(19) United States
(12) Patent Application Publication
(10) Pub. No.: US 2025/0346687 A1
(43) Pub. Date: Nov. 13, 2025

(54) METHOD FOR PREPARING ZIEGLER-NATTA CATALYST FOR POLYMERIZATION OF LINEAR LOW-DENSITY POLYETHYLENE

(71) Applicants: SK INNOVATION CO., LTD., Seoul (KR); SK GEO CENTRIC CO., LTD., Seoul (KR)

(72) Inventors: Jinhaek YANG, Daejeon (KR); Mun Hyung KANG, Daejeon (KR); Maengsun EO, Daejeon (KR)

(21) Appl. No.: 18/869,286

(22) PCT Filed: May 10, 2023
(86) PCT No.: PCT/KR2023/006328

§ 371 Date: Nov. 26, 2024

(30) Foreign Application Priority Data
May 27, 2022 (KR) 10-2022-0065092

(51) Int. Cl. C08F 4/02

(52) U.S. Cl. CPC C08F 4/022

(57) ABSTRACT

The present disclosure relates to a method for preparing a Ziegler-Natta catalyst for polymerization of linear low-density polyethylene (LLDPE), and specifically, the method for preparing a Ziegler-Natta catalyst for polymerization of linear low-density polyethylene according to an embodiment includes preparing a magnesium chloride support containing magnesium chloride alcoholate obtained by mixing an excessive amount of alcohol with magnesium chloride. In the method for preparing a Ziegler-Natta catalyst according to an embodiment, a catalyst composition is easily controlled, such that it is possible to effectively produce linear low-density polyethylene having various physical properties and excellent copolymerization performance.

### TECHNICAL FIELD

The present disclosure relates to a method for preparing a Ziegler-Natta catalyst for polymerization of linear low-density polyethylene and a method for producing linear low-density polyethylene using the Ziegler-Natta catalyst prepared therefrom.

### BACKGROUND ART

A polymerization catalyst of the Ziegler-Natta (Z/N) type is a catalyst for producing an olefin polymer, for example, an ethylene copolymer. Typically, the Ziegler-Natta catalyst contains a magnesium compound, an aluminum compound, and a titanium compound supported on a specific support.

Since the shape and size of the polymer polymerized using the Ziegler-Natta catalyst depend on the catalyst used, it is important to prepare a catalyst that may increase productivity and may produce uniformly distributed polymers.

Although a lot of development work for the preparation of the Ziegler-Natta catalyst has been carried out, some methods are not amenable to large-scale preparation of catalysts because preparation conditions are significantly sensitive or a large amount of impurities or wastes is generated. U.S. Pat. No. 8,003,741 discloses a method for preparing a Ziegler-Natta catalyst in which a magnesium compound is dissolved in alcohol and then a titanium compound is added, but the preparation process is complicated and many types of materials are used.

### DISCLOSURE

### Technical Problem

An embodiment of the present disclosure is to provide a method for preparing a Ziegler-Natta catalyst for polymerization of linear low-density polyethylene.

Another embodiment of the present disclosure is to provide a Ziegler-Natta catalyst for polymerization of linear low-density polyethylene prepared by the preparation method according to the embodiment.

Still another embodiment of the present disclosure is to provide a method for producing linear low-density polyethylene using the Ziegler-Natta catalyst for polymerization of linear low-density polyethylene according to the embodiment.

### Technical Solution

In one general aspect, a method for preparing a Ziegler-Natta catalyst for polymerization of linear low-density polyethylene comprises: sequentially adding, to a magnesium chloride support containing magnesium chloride alcoholate represented by the following Chemical Formula 1, an alkyl aluminum chloride represented by the following Chemical Formula 2 and a metal compound containing titanium (Ti) to allow a reaction to proceed:

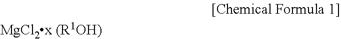

in Chemical Formula 1,
R¹ is a C₁₋₂₀ organic group; and
x is 0.01 to 3,

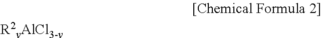

in Chemical Formula 2,
each R² is independently C₁₋₁₀ alkyl or C₃₋₁₀ cycloalkyl; and
y is 1 to 2.

In another general aspect, there is provided a Ziegler-Natta catalyst for polymerization of linear low-density polyethylene prepared by the method for preparing a Ziegler-Natta catalyst for polymerization of linear low-density polyethylene according to the embodiment.

In still another general aspect, a method for producing linear low-density polyethylene comprises bringing a monomer containing ethylene into contact with the Ziegler-Natta catalyst for polymerization of linear low-density polyethylene according to the embodiment.

### Advantageous Effects

The present disclosure relates to a method for preparing a Ziegler-Natta catalyst for polymerization of linear low-density polyethylene (LLDPE), and specifically, the method for preparing a Ziegler-Natta catalyst for polymerization of linear low-density polyethylene according to an embodiment comprises preparing a magnesium chloride support containing magnesium chloride alcoholate obtained by mixing an excessive amount of alcohol with magnesium chloride. In the method for preparing a Ziegler-Natta catalyst according to an embodiment, a catalyst composition is easily controlled, such that it is possible to effectively produce linear low-density polyethylene having various physical properties and excellent copolymerization performance.

### DESCRIPTION OF DRAWINGS

FIG. 1 is a view showing XRD data of the conventional α-phase MgCl₂ (top) and magnesium chloride ethanolate prepared in Example 1.

FIG. 2 is a view showing NMR data of the magnesium chloride ethanolate prepared in Example 1.

¹H NMR (500 MHZ, THF-d8) Ethyl alcohol δ 1.60 (t, J=7.0 Hz, 3H), 3.70 (q, J=7.0 Hz, 2H), 4.33 (s, 1H)

¹H NMR (500 MHZ, THE-d8) Toluene δ 12.33 (s, 3H), 7.16 (m, 5H)

[CH₃ Integration of CH₃ peak of Internal standard at 2.331 ppm, singlet=3.00, CH₂ Integration of —CH₂— of Ethyl alcohol at 1.160 ppm, triplet=3.911]

FIG. 3 is a view showing results of observing the magnesium chloride ethanolate prepared in Example 1 with a scanning electron microscope (SEM).

FIG. 4 is a view showing results of analyzing polymers produced using Ziegler-Natta catalysts prepared in Examples and Comparative Examples through crystallization elution fractionation (CEF).

### BEST MODEL

Embodiments disclosed in the present specification may be modified into various different forms and the technology according to an embodiment is not limited to the embodiments described below. Furthermore, in the entire specification, unless explicitly described otherwise, “comprising” any components will be understood to imply the inclusion of other components rather than the exclusion of any other components.

A numerical range used in the present specification comprises upper and lower limits and all values within these limits, increments logically derived from a form and span of a defined range, all double limited values, and all possible combinations of the upper and lower limits in the numerical range defined in different forms. As an example, when a content of a composition is limited to 10% to 80% or 20% to 50%, a numerical range of 10% to 50% or 50% to 80% should also be interpreted as described in the present specification. Unless otherwise specifically defined in the present specification, values out of the numerical ranges that may occur due to experimental errors or rounded values also fall within the defined numerical ranges.

Hereinafter, unless otherwise specifically defined in the present specification, “about” may be considered a value within 30%, 25%, 20%, 15%, 10%, or 5% of a stated value.

Hereinafter, “alkyl” in the present specification is defined as being able to mean both alkyl and cycloalkyl. In addition, even if there is no specific definition, alkyl or cycloalkyl may be construed as comprising a derivative that may be expected to exert a similar effect and may be easily modified by those skilled in the art, or alkyl or cycloalkyl substituted with a general substituent (for example, halogen or the like).

In a conventional method for preparing a Ziegler-Natta catalyst, alcohol is added to magnesium chloride to form a support in which magnesium chloride and alcohol are combined by reprecipitation, and an excessive amount of titanium tetrachloride is used to remove the alcohol combined with the magnesium chloride. However, as an excessive amount of titanium is used, it is difficult to prepare a catalyst, and a ratio of titanium supported on the support becomes non-uniform according to the reaction, which makes it difficult to reproduce catalyst performance.

An embodiment provides a method for preparing a Ziegler-Natta catalyst for polymerization of linear low-density polyethylene that may implement mild reaction conditions and minimal generation of impurities. It is possible to prepare a catalyst capable of supporting various transition metals on a support by the preparation method according to an embodiment, and it is possible to produce linear low-density polyethylene having high polymerization activity and excellent copolymerization performance using the catalyst.

An embodiment provides a method for preparing a Ziegler-Natta catalyst for polymerization of linear low-density polyethylene, the method comprising: sequentially adding, to a magnesium chloride support containing magnesium chloride alcoholate (complex) represented by the following Chemical Formula 1, an alkyl aluminum chloride represented by the following Chemical Formula 2 and a metal compound containing titanium (Ti) to allow a reaction to proceed:

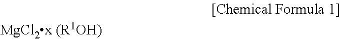

in Chemical Formula 1,
R¹ is a C₁₋₂₀ organic group; and
x is 0.01 to 3,

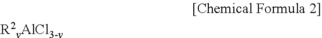

in Chemical Formula 2,
each R² is independently C₁₋₁₀ alkyl or C₃₋₁₀ cycloalkyl; and
y is 1 to 2.

In a case where linear low-density polyethylene is polymerized using the Ziegler-Natta catalyst prepared by the preparation method described above, the linear low-density polyethylene may be produced with a significantly increased yield and/or catalyst mileage. In addition, since the catalyst has an excellent comonomer reactivity, the linear low-density polyethylene produced using the catalyst may have excellent physical properties such as a high elongation because it has a high ratio of a low density region compared to commercially available linear low-density polyethylene produced by the conventional technologies.

The magnesium chloride support according to an embodiment contains magnesium chloride alcoholate which is an adduct of magnesium chloride and alcohol. As in an embodiment, in a case where alcohol is used to prepare the magnesium chloride support, the magnesium chloride may be transformed into magnesium chloride suitable for the support of the Ziegler-Natta catalyst. Alternatively, the magnesium chloride induces lattice bonding on a surface of the support, such that the performance of the catalyst may be improved. In addition, the magnesium chloride support according to an embodiment may be a spherical support.

The magnesium chloride alcoholate according to an embodiment may be prepared by a method comprising: obtaining a magnesium chloride alcoholate solution by mixing MgCl₂ with R¹OH; and
obtaining solid magnesium chloride alcoholate by subjecting the magnesium chloride alcoholate solution to pressure reduction.

In an embodiment, the obtaining of the solid magnesium chloride alcoholate may comprise a step of filtering the precipitated solid (the magnesium chloride alcoholate) by subjecting the magnesium chloride alcoholate solution to pressure reduction and then washing the filtered solid with a saturated hydrocarbon solution (for example, pentane), and then may further comprise a step of vacuum drying the washed solid. Furthermore, the obtaining of the solid magnesium chloride alcoholate may further comprise a step of heating the washed solid at a high temperature (about 70° C. to 150° C., about 70° C. to 130° C., about 80° C. to 120° C., about 90° C. to 110° C., or about 110° C.) and then vacuum-drying the heated solid under reduced pressure. The problems existing in the conventional reprecipitation method are significantly solved through the method for preparing the magnesium chloride alcoholate according to an embodiment.

In the mixing of MgCl₂ (for example, may be an anhydrous magnesium chloride) with R¹OH (for example, may be an anhydrous alcohol) according to an embodiment, it is preferable that R¹OH, which is alcohol, is added in excess. For example, a molar ratio of the magnesium chloride to the alcohol in the mixing step may be 1:5 to 1:20, 1:5 to 1:15, 1:5 to 1:12, 1:6 to 1:10, 1:7 to 1:10, or about 1:8.

The preparation method according to an embodiment may further comprise, after the adding of the metal compound to allow a reaction to proceed, additionally adding an alkyl aluminum chloride represented by Chemical Formula 2 (support activation step).

In an embodiment, the metal compound may further contain a transition metal, and for example, may further contain a Group IV or Group V metal. Specifically, the metal compound may further contain one or more metals selected from the group consisting of Zr, Hf, V, Nb, and Ta. In this case, the metal may be contained in the form of chloride, alkoxy chloride, alkylate, or the like, but this is only an example, and the metal is not limited thereto.

In an embodiment, the metal compound containing titanium (Ti) may contain TiX₄ or (R³O)_{z}Ti(X)_{4-z}. In this case, X is a halogen atom such as I, Br, Cl, or F, each R³ is independently a linear or branched C₁₋₁₀ alkyl, C₁₋₈ alkyl, C₂₋₆ alkyl, or C₁₋₅ alkyl, and z is an integer of 1 to 4. Specific examples of the metal compound comprise TiCl₄, TiBr₄, TiI₄, Ti(OBu)₄, Ti(Oi-Pr)₄, Ti(OEt)₄, Ti(OEt)₂(Cl)₂, and Ti(OEt)(Cl)₃. However, this is only an example, but the metal compound is not limited thereto.

In an embodiment, the metal compound containing titanium (Ti) may be a mixed metal compound further comprising a Group V metal compound. For example, the metal compound according to an embodiment may be a mixed metal compound of a metal compound (TiCl₄) containing titanium and a Group V metal compound (VOCl₃) containing a Group V metal.

In an embodiment, R¹ may be, for example, a methyl group, an ethyl group, an n-propyl group, an isopropyl group, an n-butyl group, an isobutyl group, an n-pentyl group, an isopentyl group, a neopentyl group, a cyclopentyl group, an n-hexyl group, an n-heptyl group, an n-octyl group, a decanyl group, a dodecanyl group, a 2-methylpentyl group, a 2-ethylbutyl group, a 2-ethylhexyl group, a cyclohexyl group, a methylcyclohexyl group, a benzyl group, a methylbenzyl group, or an isopropylbenzyl group, but this is only an example, and R¹ is not limited thereto. In an embodiment, the alcohol may be methanol, ethanol, n-propanol, isopropanol, n-butanol, isobutanol, n-pentanol, isopentanol, neopentanol, cyclopentanol, n-hexanol, n-heptanol, n-octanol, decanol, dodecanol, 2-methylpentanol, 2-ethylbutanol, 2-ethylhexanol, cyclohexanol, methylcyclohexanol, benzyl alcohol, methylbenzyl alcohol, or isopropylbenzyl, but this is only an example, and the alcohol is not limited thereto.

In an embodiment, x may be 5.0 or less, 4.0 or less, 3.0 or less, 0.5 to 5.0, 0.5 to 4.0, 0.5 to 3.0, 0.5 to 2.0, 0.8 to 2.0, or about 0.92 to 1.62, but is not limited thereto.

In an embodiment, R² may be each independently a linear or branched C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, or C₅₋₆ cycloalkyl, but this is only an example, and R² is not limited thereto.

In an embodiment, y may be, for example, 0, ½, 1, 3/2, or 2.

In an embodiment, the alkyl aluminum chloride represented by Chemical Formula 2 may be ethyl aluminum sesquichloride (C₆H₁₅Al₂Cl₃, that is, (C₂H₅)_{3/2}AlCl_{3/2}), ethyl aluminum dichloride (EtAlCl₂), methyl aluminum dichloride (MeAlCl₂), propyl aluminum dichloride (PrAlCl₂), or butyl aluminum dichloride (BuAlCl₂), and one or more alkyl aluminum chlorides may be used simultaneously or in combination. In an embodiment, the alkyl aluminum chloride may be a monomer or dimer.

In an embodiment, the alkyl aluminum chloride represented by Chemical Formula 2 is used in an amount of 10 equivalents or more with respect to the number of moles of the metal compound, such that a catalyst having more excellent activity may be prepared. For example, a molar ratio of the metal compound to the alkyl aluminum chloride represented by Chemical Formula 2 may be 1:10 to 1:50, 1:15 to 1:45, 1:20 to 1:40, 1:25 to 1:35, 1:28 to 1:32, or about 1:30. However, this is only an example, but the molar ratio is not limited thereto.

In an embodiment, a molar ratio of the metal compound to the magnesium chloride support may be 1:0.1 to 1:30, 1:1 to 1:30, 1:5 to 1:30, 1:8 to 1:30, 1:10 to 1:30, 1:5 to 1:20, 1:10 to 1:20, 1:12 to 1:18, or about 1:15. However, this is only an example, but the molar ratio is not limited thereto.

In an embodiment, the magnesium chloride support may have a peak at the following diffraction angles 29 in an X-ray diffraction pattern:
7°±2.0° to 10°±2.0°, 31°±2.0°, and 33°±2.0°.

The magnesium chloride alcoholate according to an embodiment may have a broad peak in the range of the peak value. For example, peaks at about 7.5° and 7.9° may overlap with each other. The value of the diffraction angle may comprise an error value within a range of about ±0.2°.

In an embodiment, the adding of the alkyl aluminum chloride to the magnesium chloride support may comprise a step of diluting the obtained high-purity support in a saturated hydrocarbon (for example, heptane) solution to prepare a slurry, and then adding an alkyl aluminum chloride diluted in a saturated hydrocarbon (for example, hexane) solution at room temperature (for example, about 5° C. to 25° C., about 10° C. to 25° C., about 15° C. to 25° C., or about 18° C. to 23° C.).

In an embodiment, a particle size of the magnesium chloride support may be about 5 μm to 80 μm, 10 μm to 80 μm, 20 μm to 60 μm, 10 μm to 50 μm, 20 μm to 40 μm, or about 40 μm (±20%) when measured based on SEM analysis.

Another embodiment provides a Ziegler-Natta catalyst for polymerization of linear low-density polyethylene prepared by the method for preparing a Ziegler-Natta catalyst for polymerization of linear low-density polyethylene according to an embodiment.

Still another embodiment provides a method for producing linear low-density polyethylene using the Ziegler-Natta catalyst for polymerization of linear low-density polyethylene according to an embodiment. Specifically, the method for producing linear low-density polyethylene comprises bringing an olefin monomer containing ethylene into contact with the Ziegler-Natta catalyst for polymerization of linear low-density polyethylene according to an embodiment. In an embodiment, the olefin monomer may further comprise, for example, an olefin monomer having 2 to 20, 2 to 15, or 4 to 10 carbon atoms. For example, the olefin monomer may be propylene, butene, pentene, hexene, heptene, octene, nonene, or decene, and specifically, may be 1-propylene, 1-butene, 1-pentene, 1-hexene, 1-heptene, 1-octene, 1-nonene, or 1-decene. However, this is only an example, but the olefin monomer is not limited to the olefins.

In an embodiment, a density of the linear low-density polyethylene may be 0.91 g/mL to 0.94 g/mL, 0.912 g/mL to 0.938 g/mL, 0.915 g/mL to 0.935 g/mL, or 0.915 g/mL to 0.924 g/mL, but this is only an example, and the density of the linear low-density polyethylene is not limited thereto. In an embodiment, a melt index (MI) of the linear low-density polyethylene may be 1.0 g/10 min to 5.0 g/10 min, 1.0 g/10 min to 4.0 g/10 min, 1.0 g/10 min to 3.5 g/10 min, 1.0 g/10 min to 3.0 g/10 min, 1.0 g/10 min to 2.5 g/10 min, 1.5 g/10 min to 2.5 g/10 min, or 1.6 g/10 min to 2.3 g/10 min, when measured at about 190° C. according to ISO 1133:1997 or ASTM D1238:1999, but this is only an example, and the melt index of the linear low-density polyethylene is not limited thereto.

### MODE FOR INVENTION

Hereinafter, Examples and Experimental Examples will be described in detail below. However, Examples and Experimental Examples to be described below are merely illustrative of a part of an embodiment, and the technology described in the present specification is not limited thereto.

### Example 1

Into a 500 mL Schlenk flask, 20 g (0.21 mol) of anhydrous magnesium chloride was injected, and 250 mL of heptane was injected. Then, stirring was performed. The stirring was performed to prevent agglomeration, the internal temperature of the reactor was raised to a temperature of about 70° C. to 80° C., and then 77 g (1.70 mol) of anhydrous ethanol was slowly added dropwise and stirred to prevent agglomeration, thereby preparing a transparent dissolved magnesium chloride solution. After the magnesium chloride was dissolved, the pressure was reduced slowly to remove the ethanol inside the flask. As the ethanol was removed, magnesium chloride ethanolate started to precipitate. An amount of ethanol similar to the initial amount was removed, and then the precipitated magnesium chloride was filtered, washed twice or more with 100 mL of pentane, and vacuum dried to recover magnesium chloride ethanolate. In order to remove an ethanol residue of the vacuum-dried magnesium chloride ethanolate, the magnesium chloride ethanolate was heated to 100° C. and vacuum dried under reduced pressure, thereby obtaining a white powdery magnesium chloride ethanolate support (MgCl₂·n(EtOH)).

190 mg (2.00 mmol) of the magnesium chloride ethanolate support was transferred to a transparent vial, 10 mL of heptane was added, and stirring was sufficiently performed for dispersion. Thereafter, 0.54 mL (0.53 mmol) of a 1.0 M C₂H₅AlCl₂ hexane solution diluted in hexane was injected, and stirring was performed at room temperature for 6 hours or longer. Thereafter, 1.1 mL (0.14 mmol) of 5 wt % TiCl₄ was slowly added dropwise, and stirring was performed for 12 hours or longer. In addition, 3.5 mL (3.50 mmol) of a 1.0 M C₂H₅AlCl₂ hexane solution was slowly added dropwise, and stirring was performed for 12 hours or longer, thereby preparing a pink magnesium chloride supported catalyst (Ziegler-Natta catalyst) heptane slurry solution.

### Examples 2 and 3

Magnesium chloride supported catalyst (Ziegler-Natta catalyst) heptane slurry solutions were prepared in the same manner as that of Example 1 except that the metal compounds were used as shown in Table 1.

### Comparative Example 1

Into a 500 mL flask, 33 mL (30 mmol) of a 0.9 M ethyl normal butyl magnesium heptane solution was injected, and then 127 mL of normal heptane was injected. Before adding hydrogen chloride (HCl) gas, the internal temperature of the reactor was lowered to 0° C., and the stirring was performed using a magnetic stirrer. Anhydrous hydrogen chloride gas was injected at a constant rate until residual alkyl magnesium Grignard was not observed, and the reaction was terminated, thereby preparing a 0.2 M magnesium chloride support heptane slurry solution.

Thereafter, 10 mL (2.00 mmol) of the prepared 0.2 M magnesium chloride support solution was transferred to a transparent vial, 0.52 mL (0.52 mmol) of a 1.0 M C₂H₅AlCl₂ solution diluted in hexane, as an alkyl aluminum chloride, was injected, and stirring was performed at room temperature for 6 hours or longer. Thereafter, 1.0 mL (0.13 mmol) of 5 wt % TiCl₄ was slowly added dropwise, and stirring was performed for 12 hours or longer, thereby preparing a brown magnesium chloride supported catalyst (Ziegler-Natta catalyst) heptane slurry solution.

### Comparative Example 2

A process was performed in the same manner as that of Comparative Example 1, but the alkyl aluminum chloride was used as shown in Table 1. As a result, a catalyst was not obtained.

TABLE 1

| | Alkyl aluminum | | |
|---|---|---|---|
| | chloride | Metal compound | Support |
| Example 1 | A, 30.0 | B, 1.0 | 15.0 |
| | equivalents | equivalent | equivalents |
| Example 2 | | C, 1.0 | |
| | | equivalent | |
| Example 3 | | D, 1.0 | |
| | | equivalent | |
| Comparative | A, 4.0 equivalents | B, 1.0 | |
| Example 1 | | equivalent | |
| Comparative | A, 30.0 | | |
| Example 2 | equivalents | | |

1) Alkyl aluminum chloride A: Ethyl aluminum dichloride (C₂H₅AlCl₂)

2) Metal compound

B: TiCl₄; C: Ti(Oi-Pr)₄; D: TiCl₄+VOCl₃ (molar ratio=1:1)

### <Experimental Example 1> X-Ray Diffraction (XRD) Analysis

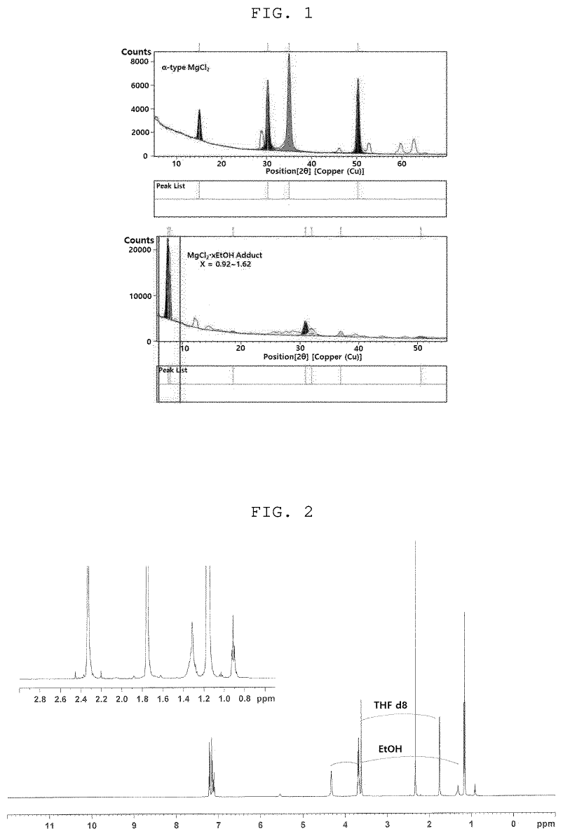

XRD analysis was performed under the following equipment and analysis conditions to obtain an XRD spectrum of the magnesium chloride ethanolate support prepared in Example 1 (FIG. 1).

Maker: Empyrean; X-ray Source Anode: Cu; Generator Voltage: 45 kV, Tube Current: 40 mA; Incidence Beam: BBHD; Divergence Slit: ¼°; Anti-scatter Slit: 1°; Detector: PIXcel Detector; Sample Stage: Reflection Transmission Spinner

FIG. 1 illustrates XRD spectra of the conventional α-phase MgCl₂ and the magnesium chloride ethanolate (MgCl₂·n(EtOH), n=0.92 to 1.62) prepared in Example 1. In the case of the magnesium chloride ethanolate (MgCl₂ n (EtOH), n=0.92 to 1.62) prepared in Example 1, a broad peak (peaks at 7.5° and 7.9° overlapped with each other) was confirmed at a diffraction angle (2θ) around about 7° to 10°.

### <Experimental Example 2> Nuclear Magnetic Resonance (NMR) Analysis

NMR analysis was performed under the following equipment and analysis conditions to obtain an XRD spectrum of the magnesium chloride ethanolate support prepared in Example 1.

Instrument Maker: Bruker; Power Hz: 500 MHz; NMR Solvent: THF-d8

First, toluene and the magnesium chloride ethanolate prepared in Example 1 were stirred and completely dissolved in THF-d8 as an NMR analysis solvent, and then 1H NMR was measured (FIG. 2). Then, a molar ratio of toluene to ethanol was calculated, and the final weight of ethanol was estimated. As a result, the molar ratio of magnesium chloride to ethanol in the magnesium chloride ethanolate was 1:0.92 to 1:1.62.

### <Experimental Example 3> Scanning Electron Microscope (SEM) Analysis

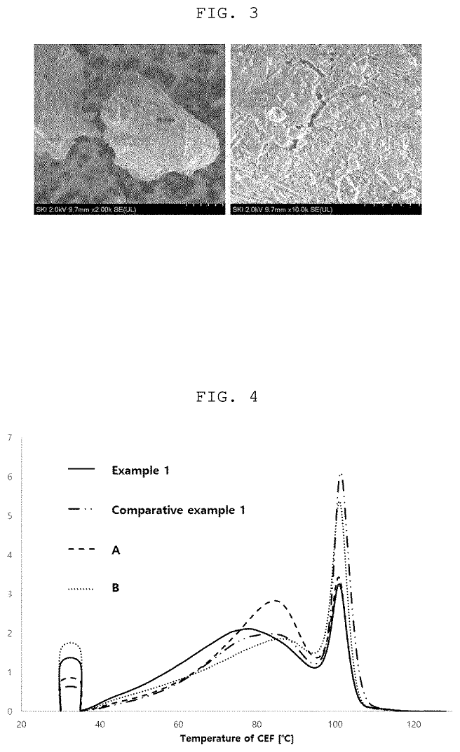

SEM analysis of the magnesium chloride ethanolate prepared in Example 1 was performed under the following conditions. The results thereof are illustrated in FIG. 3.

Manufacturer: HITACHI, Model: SU8230, Mode: SE, Detector: SE, Acceleration Voltage: 5 kV, Current: 10 μA

As a result of measuring the particle size of the magnesium chloride ethanolate based on the SEM results, it could be confirmed that particles having a size of about 40 μm±20% were mainly produced.

### <Experimental Example 4> Polymerization of Linear Low-Density Polyethylene

An autoclave reactor was filled with 0.5 L of a saturated hydrocarbon solvent (methylcyclohexane) in a stable anhydrous nitrogen state, 0.2 g (0.15 mol) of triethyl aluminum and 100 mL (70 g, 0.7 mol) of 1-octene were injected, the temperature of the reactor was raised to 180° C., stirring was performed, and then ethylene was injected into the reactor at 30 bar. The catalysts (1.7 μmol) prepared in Examples 1 to 3 and Comparative Example 1 were diluted with a saturated hydrocarbon solvent (methylcyclohexane) (3 mL), and each of the catalysts was transferred to a catalyst port, and the catalyst port was pressurized with anhydrous nitrogen (50 bar). After the inside of the autoclave reactor was saturated with ethylene, the catalyst was injected from the catalyst port into the reactor under an isothermal condition of 180° C., and semi-batch polymerization with a continuous supply of ethylene was performed for 10 minutes. Thereafter, the reactant was recovered through an outlet and the solvent was dried to obtain a linear low-density copolymer (linear low-density polyethylene (LLDPE)). The yield, catalyst mileage, melt index, and density of the obtained linear low-density polyethylene were measured. The results thereof are shown in Table 2.

At this time, the catalyst mileage was defined as a value obtained by dividing the mass of the produced LLDPE by the mass of the catalyst. The melt index was measured by conducting a test at 190° C. according to the ASTM D1238 standard, and the density was measured with a density gradient column.

TABLE 2

| | | Catalyst | | |
|---|---|---|---|---|
| | | mileage | | |
| | LLDPE | (LLDPE | | |
| | yield | ton/catalyst | MI | Density |
| | (g) | kg) | (g/10 min) | (g/mL) |
| Example 1 | 20.53 | 7.78 | 2.172 | 0.92 |
| Example 2 | 17.67 | 6.70 | 1.892 | 0.92 |
| Example 3 | 22.80 | 8.65 | 2.053 | 0.92 |
| Comparative | 8.26 | 2.14 | 0.76 | 0.92 |
| Example 1 | | | | |
| Comparative | — | — | — | — |
| Example 2 | | | | |

Referring to Table 2, it can be seen that the yield of the copolymer is significantly increased when the polymerization is performed using the catalysts prepared in Examples, compared to the case where the polymerization is performed using the catalysts for polymerization of linear low-density polyethylene prepared in Comparative Examples.

### <Experimental Example 5> Crystallization Elution Fractionation (CEF)

In order to analyze the physical properties of the polymers prepared using the catalysts of Examples and Comparative Examples through crystallization elution fractionation (CEF), a test was conducted using POLYMER-CHAR CRYTEX-42 instrument and a trichlorobenzene (TCB) solution. At this time, commercial product A (Dow Chemical Company) and commercial product B (SK Chemicals Co., Ltd.) were prepared and tested as comparative groups. The results thereof are illustrated in FIG. 3.

Through the above experiments, it could be confirmed that, in the cases of the polymers produced using the catalysts of Examples, the ratio of the high density region (homopolymer) at about 80° C. to 100° C. was low and the ratio of the low density region (copolymer) at about 50° C. to 80° C. was high in the CEF spectrum compared to the commercial products. Therefore, it can be seen that a low-density copolymer having a high elongation may be effectively prepared using the catalysts of Examples.

Hereinabove, one embodiment has been described in detail through preferred Examples and Experimental Examples, but the scope of one embodiment is not limited to a specific embodiment, and should be interpreted according to the appended claims.

1. A method for preparing a Ziegler-Natta catalyst for polymerization of linear low-density polyethylene comprising:
sequentially adding, to a magnesium chloride support containing magnesium chloride alcoholate represented by the following Chemical Formula 1, an alkyl aluminum chloride represented by the following Chemical Formula 2 and a metal compound containing titanium (Ti) to allow a reaction to proceed: 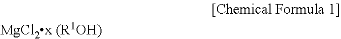
in Chemical Formula 1,
R¹ is a C₁₋₂₀ organic group; and
x is 0.01 to 3, 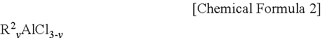
in Chemical Formula 2,
each R² is independently C₁₋₁₀ alkyl or C₃₋₁₀ cycloalkyl; and
y is 1 to 2.

2. The method of claim 1, wherein the magnesium chloride alcoholate represented by Chemical Formula 1 is prepared by a method comprising:
obtaining a magnesium chloride alcoholate solution by mixing MgCl₂ with R¹OH; and
obtaining solid magnesium chloride alcoholate by subjecting the magnesium chloride alcoholate solution to pressure reduction.

3. The method of claim 1, further comprising, after the adding of the metal compound to allow a reaction to proceed, additionally adding an alkyl aluminum chloride represented by Chemical Formula 2.

4. The method of claim 1, wherein the metal compound further contains a Group IV or Group V metal.

5. The method of claim 1, wherein x is 0.5 to 2.0.

6. The method of claim 1, wherein each R² is independently C₁₋₆ alkyl or C₃₋₆ cycloalkyl, and
y is 1 to 2.

7. The method of claim 1, wherein the metal compound and the alkyl aluminum chloride represented by Chemical Formula 2 are added at a molar ratio of 1:10 to 1:50.

8. The method of claim 1, wherein the metal compound and the magnesium chloride support react with each other at a molar ratio of 1:0.1 to 1:30.

9. The method of claim 1, wherein the metal compound contains TiX₄ or (R³O)_{z}Ti(X)_{4-z} where X is a halogen atom, each R³ is independently C₁₋₁₀ alkyl, and z is an integer of 1 to 4.

10. The method of claim 9, wherein the metal compound is a mixed metal compound further containing a compound containing a Group V metal.

11. The method of claim 1, wherein the alkyl aluminum chloride is EtAlCl₂, MeAlCl₂, PrAlCl₂, BuAlCl₂, or (C₂H₅)_{3/2}AlCl_{3/2}.

12. A Ziegler-Natta catalyst for polymerization of linear low-density polyethylene prepared by the method for preparing a Ziegler-Natta catalyst for polymerization of linear low-density polyethylene of claim 1.

13. A method for producing linear low-density polyethylene, comprising bringing ethylene into contact with the Ziegler-Natta catalyst for polymerization of linear low-density polyethylene of claim 12.

14. The method of claim 13, wherein a density of the linear low-density polyethylene is 0.91 g/mL to 0.94 mL, and a melt index (MI) of the linear low-density polyethylene is 1.0 g/10 min to 5.0 g/10 min when measured according to ASTM D1238.
